(19) United States
(12) Patent Application Publication
(10) Pub. No.: US 2018/0076448 A1
(43) Pub. Date: Mar. 15, 2018

(54) Electrode, Method for Producing an Electrode and Energy Store having an Electrode

(71) Applicant: Robert Bosch GmbH, Stuttgart (DE)

(72) Inventors: Ingo Zeitler, Tamm (DE); Juergen Hackenberg, Sachsenheim (DE); Benjamin Walther, Geldern (DE)

(21) Appl. No.: 15/822,310

(22) Filed: Nov. 27, 2017

Related U.S. Application Data
(62) Division of application No. 14/365,314, filed on Jun. 13, 2014.

(30) Foreign Application Priority Data
Dec. 14, 2011 (DE) 10 2011 088 533.1

(51) Int. Cl. H01M 4/1395; H01M 4/38; H01M 10/0525; H01M 4/04; H01M 4/134; H01M 4/02

(52) U.S. Cl. CPC H01M 4/1395; H01M 4/386; H01M 10/0525; H01M 2004/022; H01M 4/134; H01M 4/0471; H01M 4/0402

(57) ABSTRACT

A method for producing an electrode having an electrically conductive base element on which there is arranged an active material comprising a silicon nanostructure includes introducing a precursor mixture comprising a silicon-containing material and a base matrix into a spinning unit, arranging an electrically conductive base body at a defined distance from a delivery device of the spinning unit, and delivering at least part of the precursor mixture from the delivery device to the base body. The method further includes applying an electrical voltage between at least part of the spinning unit and the base body so as to spin a silicon-containing nanostructure onto the base body, heat-treating the silicon-containing nanostructure, removing the heat-treated nanostructure from the base body, processing the removed nanostructure to a slurry, and applying the slurry to the base element to produce the electrode.

This application is a divisional of U.S. application Ser. No. 14/365,314, filed on Jun. 13, 2014, which in turn is a 35 U.S.C. § 371 National Stage Application of PCT/EP2012/070872, filed on Oct. 22, 2012, which in turn claims the benefit of priority to Serial No. 10 2011 088 533.1 filed on Dec. 14, 2011 in Germany, the disclosures of which are hereby totally incorporated by reference in their entirety.

The disclosure relates to an electrode, to a method for producing an electrode, and to an energy storage device comprising an electrode. The disclosure relates more particularly to a method for producing an electrode having a silicon-based active material, the electrode featuring an enhanced cycling stability.

### BACKGROUND

Conventional, commercially available lithium ion batteries typically comprise, on the anode side, graphite as active material, which is capable of reversible insertion of lithium ions. The maximum theoretical capacity through insertion of lithium in graphite is limited to about 372 mAh/g, possibly limiting the capacity of the overall battery per unit mass to approximately 140 Wh/kg. For a large number of applications, this capacity may be sufficient.

If, however, the desire is for higher capacities for a given weight, the graphite active material of the anode may be replaced, for example. Suitable alternative active materials include metal oxides or silicon-based materials and/or silicon, which are likewise capable of reversible insertion of lithium ions. In the case of silicon, for example, alloys may be formed up to the point of a statistical distribution of Li_{4.4}Si. As a result, the theoretically attainable capacity for anodes may be 4200 mAh/g.

When silicon is used as active material, however, it is known that the insertion of lithium ions may be accompanied by volume expansion of the silicon. Under certain circumstances, consequently, compact layers of silicon may tend after just a few charge/discharge cycles toward cracking and, for instance, detachment from the current collector. As a consequence of this, the detached silicon is no longer available for lithiation, and this may result in a falling capacity in a battery after just a few cycles.

The publication CN 1895993 discloses an electrode of a lithium accumulator, this electrode having a carbon base body with a silicon nanowire applied to the carbon base body. This silicon nanowire has a diameter of 1 nm-500 nm and a length of 5 nm-200 μm. According to this publication, the electrode is produced on the base body by chemical vapor deposition of the silicon.

### SUMMARY

The disclosure provides a method for producing an electrode having an electrically conductive base body, arranged on which there is an active material comprising a silicon nanostructure, the method comprising the steps of introducing a precursor mixture comprising a silicon-containing material and a base matrix into a spinning unit; arranging the base body at a defined distance from a delivery means of the spinning unit; delivering at least part of the precursor mixture from the delivery means; applying a voltage between at least part of the spinning unit and the base body, to spin a silicon-containing nanostructure onto the base body; and heat-treating the silicon-containing nanostructure.

A silicon nanostructure in the sense of the disclosure may in particular be a structure comprising elemental silicon and optionally a further material. This structure may have an extent in at least one dimension in the nanometer range. For example, the nanostructure may comprise particles or wirelike or fiberlike structures having a diameter which may be situated in a range from ≧1 nm to ≦1000 nm, as for example from ≧10 nm to ≦100 nm.

An active material in the sense of the disclosure may be more particularly a substance which when the electrode of the disclosure is used in lithium-based accumulators, for example, is able reversibly to take up and give up lithium ions. The uptake here may take place, for example, by intercalation or else by alloy formation and/or the formation of a metastable chemical compound. In the case of other uses, more particularly other accumulators, there may be a corresponding activity in relation to other substances. Overall, an active material may be understood to be a material which participates in an electrochemical reaction that takes place in the context of a charging or discharging operation.

A silicon-containing material in the sense of the disclosure may be more particularly elemental silicon or else a substance which comprises silicon and from which elemental silicon can be generated in a method step. Accordingly, for example, the silicon-containing material may be or comprise a silicon precursor. In that case, it is present together with a base matrix in a precursor mixture, in other words in a mixture which may serve as a starting mixture for the method of the disclosure. The base matrix in this case, in the sense of the disclosure, may form in particular a matrix for the silicon-containing material, in which the latter is disposed or distributed. The base matrix may prevent or reduce, for example, agglomeration of the silicon-containing material.

In accordance with the disclosure, the precursor mixture is introduced into a spinning unit. This spinning unit is designed more particularly to implement an electrospinning process. For this purpose it has, for example, a delivery means, from which the precursor mixture can be delivered in a defined manner. The delivery means may be formed, for example, by a suitable nozzle. The precursor mixture may be introduced into a reservoir container, which is connected to the delivery means in such a way that the precursor mixture can be delivered in a defined manner by the delivery means.

At a defined distance from the delivery means of the spinning unit, a base body may be arranged. In the sense of the disclosure, this base body may be, for example, a substrate which may be used directly in the electrode that is to be generated, and which in that case may impart, in particular a large part of the mechanical stability to the electrode that is to be generated, and/or may serve, for example, as a current output conductor. Accordingly, the base body is, in particular, electrically conductive. In accordance with the disclosure, a voltage may be applied between at least part of the spinning unit, such as, in particular, the delivery means, and the base body and this may include the application of a voltage between a component connected to the delivery means and a component connected to the base body. If, then, additionally, the precursor mixture is expressed or delivered in a defined manner from the delivery means, such as a nozzle, for instance, then by means of an electrospinning process it is possible to apply or spin a defined, silicon-containing nanostructure, surrounded by the base matrix, onto the base body. The nature of the applied structure here may be dependent on a multiplicity of variables, such as, for instance, the nature of the matrix, nature of silicon-containing material, rate of emergence from the delivery means, applied voltage, distance between delivery means and substrate, or any relative movement of substrate in relation to delivery means, or vice versa. In other words, through a suitable combination or variation particularly of the aforementioned variables, the skilled person is able to tailor the nature and design of the silicon-containing nanostructure applied.

In a further method step, the silicon-containing nanostructure may be heat-treated. In the sense of the disclosure, this may mean, in particular, that the silicon-containing nanostructure is subjected to a defined temperature treatment. The heat treatment may result, first, in the formation of elemental silicon from the silicon-containing material, where there is no elemental silicon present in the precursor mixture. Furthermore, for example, the base matrix may be decomposed by heat and may be removed from the surface of the silicon-containing nanostructure, as for instance when a volatile matrix or oxidizable matrix is used. In a further embodiment, the base matrix may suitably undergo a reaction, leaving the reaction products as a shell on the silicon-containing nanostructure. In this step, when a carbon-containing base matrix is used, for instance, carbon from the matrix may remain on the surfaces of the silicon nanostructure and may electrically connect the silicon-containing nanostructure and/or improve the electrical connection of the silicon nanostructure to the base body. Where elemental silicon is already present in the precursor mixture, the silicon nanostructure may correspond to, or be, the silicon-containing nanostructure. In this case, the heat-treating step may in one embodiment treat only the base matrix, or a shell surrounding the silicon. In principle, however, the three-dimensional design of the nanostructure as well may be modified during the heat treatment.

By means of the method of the disclosure it is possible to produce an electrode with an active material which is reversibly lithiatable and therefore suitable, for example, for use in a lithium-based energy storage device. An energy storage device produced with the electrode of the disclosure has a high capacity, through the utilization of silicon as active material, and this capacity may be sufficient and suitable for a multiplicity of applications.

Furthermore, owing to its formation as a nanostructure, the active material has an enhanced cycling resistance. In detail, as a result of the small extent of the nanostructure, the absolute increase in volume of the active material as a result, for instance, of lithiation may remain limited. As a result, instances of damage brought about by volume effects which occur in the course of a cycle may be reduced or even prevented entirely. Furthermore, the swelling-induced destruction that occurs, for instance, in compact silicon plies during cycling is absent. In accordance with the disclosure, therefore, an electrode can be produced that is particularly long-lived by virtue of a high cycling stability.

The method of the disclosure is based, furthermore, on an electrospinning process. This is a process which is well established and readily manageable within wide sectors, including industrial sectors. As a result it is possible in accordance with the disclosure, without problems, to produce electrodes having reproducible and precisely defined properties. Through the application of an electrospinning process, the method of the disclosure is particularly simple and inexpensive. It allows costly and inconvenient template syntheses, via silicon dioxide (SiO₂), for instance, or expensive gas-phase deposition to be avoided. As a result, an industrial manufacture of electrodes is also made possible and/or improved.

The nanostructure produced in accordance with the disclosure can be used together with the base body, immediately after production, directly as the active material of an anode of, for instance, a lithium-based energy storage device. In this context it is possible to achieve capacities of up to 4000 mAh/g in conjunction with very good cycling stability.

The possibilities for use of the method of the disclosure are very variable, and so through the choice of the reaction conditions it is possible for the desired silicon nanostructure to be applied to the base element in a defined and reproducible manner. Accordingly, by adapting the reaction conditions, such as the nature of the matrix, nature of the silicon-containing material, rate of emergence from the delivery means, the applied voltage, the distance between delivery means and substrate, or any movement of substrate relative to delivery means or vice versa, it is possible to produce, for instance, silicon-containing nanofibers, nanoparticles, or nanomeshes. It is possible to produce either elemental silicon fibers or else conductive hybrid fibers of silicon and the base matrix, each of which may be shaped to the desired extent.

In one embodiment, the base matrix may comprise or consist of a polymer, which more particularly may be selected from the group consisting of or comprising polyethylene (PE), polypropylene (PP), polystyrene (PS), or polycaprolactone (PCL). In a base matrix of this kind, the silicon-containing material may be present in particularly well-distributed form, and is also highly suitable for an electrospinning process. Furthermore, if the base matrix present is a polymer, it will be converted in a temperature treatment of the disclosure, such as, more particularly, in the method step of heat-treating, into a carbon layer, which is electrically conductive. As a result it is possible to produce a structure which has silicon surrounded by or encased in a carbon shell. This carbon shell may offer protection from silicon agglomeration occurring as a result of charge and discharge cycles, and hence in particular the cycling stability of the electrode, or of an energy storage device equipped with the electrode, may be further improved. In addition, the carbon layer may improve the electrical connection of the silicon to the base body, in other words, for instance, to the current collector.

In a further embodiment, the silicon-containing material may be selected from alkylsilanes, arylsilanes, or silicon nanoparticles. Materials of this kind can be distributed effectively in a base matrix and can then be used suitably for a precursor mixture. Furthermore, materials of these kinds, distributed in a base matrix, can be spun electronically in a desired way in order to generate the desired nanostructure. Thus, for example, by adjusting the length of the alkyl groups in alkylsilanes and, for instance, the proportion of base matrix in the precursor mixture, it is possible to select the amount-of-substance fractions in the resulting structure in such a way that different properties are achievable. Thus, for example, the thickness of a shell, as for instance a carbon shell, may be varied such that a structure—more particularly a fiber, for instance—breaks down into individual particles during a temperature treatment. These particles may also have a structure comprising a silicon core with a carbon shell. When silicon nanoparticles are used, they are already present in the form of silicon in a suitable size. As a result, subsequent method steps, such as the formation of a defined structure in particular, may be simplified, thereby allowing the method to be made simpler and more cost-effective. Especially when silicon nanoparticles are being used, they may be provided on their surface with an auxiliary, in order to prevent agglomeration. Auxiliaries which may be used include, for instance, polyacrylates, which may alter the surface charge of the particles. The silicon particles may be present, furthermore, in a size of ≧1 nm to ≦100 nm.

In a further embodiment, the heat-treating may be carried out in the absence of oxygen. As a result, for example, the base matrix, such as more particularly the hydrocarbon fraction of a polymer, may be decomposed to carbon, but oxidation of the silicon and/or of the carbon can be particularly effectively prevented. For this purpose, the heat-treating may be carried out, for instance, under inert gas or in a reducing atmosphere. Alternatively or additionally, the heat-treating may be carried out at a temperature in a range from ≧800 to ≦1000° C. For a large number of materials used as base matrix or as silicon-containing material, such temperatures are sufficient to heat-treat said materials, but this method step can be carried out in an energy-saving and hence cost-reducing way. Furthermore, when temperatures of these kinds are used, there are no disproportionate demands placed on the corresponding apparatus components in terms of temperature stability. Alternatively or additionally, the heat-treating may be carried out for a period of ≧1 hour to ≦7 hours. Through the use of such a period, the method is time-saving and hence can be applied without problems even in large production runs, with this period being sufficient for a heat-treating operation to generate the desired structure, for many fields of application.

In a further embodiment, a base structure may be used which is formed of copper, and/or of aluminum. Such materials are electrically conductive, and so highly suitable for an electrospinning procedure. Furthermore, such base structures may serve directly as current collectors or as base element of the electrode for instance, thereby simplifying the further production of the electrode and making it particularly inexpensive.

In a further embodiment, the applied voltage may generate an electrical field of a magnitude in a range from ≧100 kV/m to ≦500 kv/m, the voltage here being stated relative to a distance between delivery means and substrate. Voltages of these kinds are suitable particularly for electrospinning of a silicon-containing material, and silicon-containing structures in the nanometer range, in particular, can be formed in a desired way.

In a further embodiment, a wirelike silicon nanostructure can be produced that has a length of >200 μm. A structure of this kind may feature particularly good capacities in conjunction with a particularly simple production step. In detail, a structure of this kind can be formed suitably into, for instance, an unordered fiber structure, such as a coil, for example, or an ordered fiber, such as a weave structure, for example. This may be realized in a desired way, for example, by a displacement of substrate relative to the delivery means. As a result, particularly advantageous properties can be achieved in the active material, and may further be adapted to the desired utility in a desired way. In detail, a fiber or a mesh are structures through which a particularly high capacity can be achieved, and damage to the active material by a multiplicity of charge and discharge cycles can be particularly effectively reduced or prevented. The properties here are adjustable through the defined arrangement or orientation of the structure. In the sense of the disclosure, a wirelike structure here may be more particularly a structure which has a high length in relation to its diameter, and may have, for example, a round or oval cross section.

The disclosure further provides an electrode, more particularly an anode, for a lithium-based energy storage device, comprising a base body, disposed on which there is an active material, the active material having a silicon nanostructure comprising silicon nanoparticles or a silicon wire, the silicon wire having a length of >200 μm. An electrode of the disclosure has, in particular, the advantages described in relation to the method of the disclosure. More particularly an electrode of the disclosure has a high capacity in conjunction with very good cycling stability. By virtue of the silicon wire having a length of >200 μm, it is possible here to achieve a particularly suitable structure for the silicon wire and for the active material. In this way, the capacity and/or cycling behavior can be adapted particularly easily to the desired field of application. For the purposes of the disclosure, a lithium-based energy storage device may more particularly be any energy storage device in which lithium or a lithium species finds use in a charge or discharge process. Examples of a lithium-based energy storage device include lithium ion batteries or lithium polymer batteries. The use of the term “battery” in the sense of the disclosure encompasses primary batteries but also, in particular, secondary batteries, or accumulators.

In one embodiment, the silicon nanostructure may form a fiber or a mesh. A fiber or a mesh is a structure through which a particularly high capacity can be achieved, allowing damage to the active material as a result of a multiplicity of charge and discharge cycles to be particularly effectively reduced or prevented. A mesh in the sense of the disclosure, in particular, may be a structure in which the silicon or the silicon wire is interwoven with itself. A mesh here may be an ordered structure, such as a weave structure, for instance, or else an unordered structure, such as a coil, for instance.

The disclosure further provides an energy storage device, more particularly a lithium-based energy storage device, comprising at least one electrode. An energy storage device has, in particular, the advantages described in relation to the electrode of the disclosure. In particular, an energy storage device has a high capacity in conjunction with very good cycling stability.

### BRIEF DESCRIPTION OF THE DRAWINGS

Further advantages and advantageous embodiments of the subject matter of the disclosure will be illustrated by the drawings and elucidated in the description below. It should be borne in mind here that the drawings have only a descriptive character, and are not intended to restrict the disclosure in any form. In the drawings,

FIG. 1 shows a schematic representation of a spinning unit for implementing the method of the disclosure; and

FIG. 2 shows a schematic representation showing the heat-treating step of the method of the disclosure.

### DETAILED DESCRIPTION

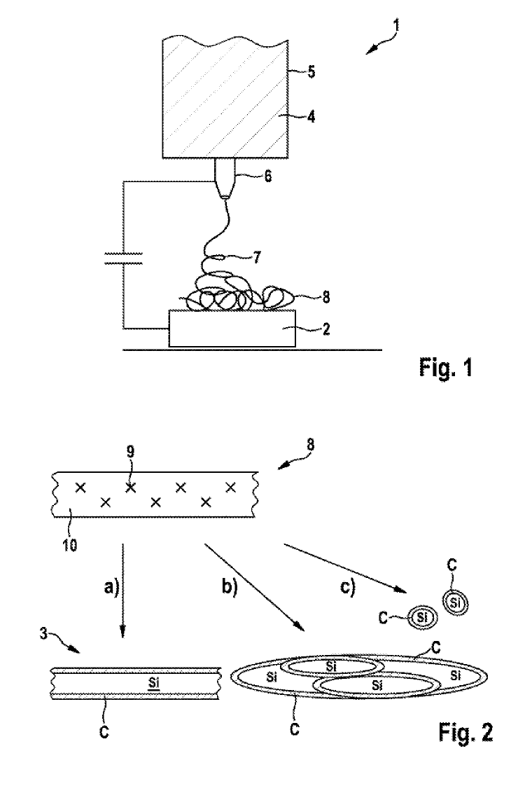

FIG. 1 shows a schematic representation of a spinning unit 1 for implementing the method of the disclosure. In accordance with the disclosure it is possible in particular to produce an electrode having an electrically conductive base body 2, disposed on which there is an active material comprising a silicon nanostructure 3. An electrode of this kind may find use in particular in a lithium-based energy storage device, such as a lithium ion battery, a lithium polymer battery, or a thin-film lithium battery, for example.

In accordance with the disclosure a precursor mixture 4 is first introduced into the spinning unit 1. For this purpose, the spinning unit 1 may have, for example, a container 5 for the precursor mixture 4. This precursor mixture 4 comprises a silicon-containing material and a base matrix. This silicon-containing material may be selected from alkylsilanes, arylsilanes, or silicon nanoparticles. The base matrix may comprise a polymer, which more particularly may be selected from the group consisting of polyethylene, polypropylene, and polystyrene, polycaprolactone. Furthermore, the precursor mixture 4 may further comprise a solvent, which may be selected in respect of the polymer. Suitable solvents may be aromatics, alcohols, or ketones, for example.

The spinning unit 1, in particular on the container 5 or on its underside, additionally has a delivery means 6, such as a nozzle, for example. The base body 2 is disposed at a defined distance from the delivery means 6 of the spinning unit 1. The base body 2 may be formed of copper and/or aluminum, for example, or may consist of this or these materials. At least part of the precursor mixture 4 may then be delivered from the delivery means 6 or from the container 5. Additionally, between at least part of the spinning unit 1 and the base body 2, a voltage may be applied. A voltage may be used, for example, that generates an electrical field that is situated within a range from ≧100 kV/m to ≦500 kv/m. Furthermore, the voltage may be applied, for instance, between the base body 2 and the delivery means 6. The application of the voltage allows the electrospinning process itself to be carried out, in which a silicon-containing nanostructure 8, embedded in the base matrix, is spun onto the base body 2, in the way in which the flow 7 of the precursor mixture 4 is intended to show.

The silicon-containing nanostructure 8 that has been generated can subsequently be heat-treated, in order to produce a silicon nanostructure 3. The heat treatment may be carried out for instance in the absence of oxygen. Other advantageous conditions for the heat treatment include temperatures in a range from ≧800 to ≦1000° C. and/or periods in a range from ≧1 to ≦7 hours.

The heat treatment produces a silicon nanostructure, in which silicon may be encased, for example, in a further material, such as carbon, for instance, when a polymer is used as base matrix. Depending on the conditions employed, the silicon nanostructure may comprise particles, a fiber, or a mesh. This is shown in FIG. 2. In accordance with FIG. 2, a matrix 10, which is more particularly the base matrix, comprises a multiplicity of elements 9, more particularly of finely divided elements 9, of the silicon-containing material. As a result of different reaction conditions a), b), and c), particularly in the case of a heat-treating step or else of the actual electrospinning process, it is then possible to set the precise formation, such as the spatial arrangement, for instance, of the silicon nanostructure.

FIG. 2 describes in a nonrestricting manner a reaction of a precursor mixture 4 comprising a polymer. In principle it is possible here for a silicon nanostructure to be formed, with the silicon encased in carbon. This is indicated by the carbon shell C. In the case of the reaction a), for example, a silicon wire or a silicon fiber may be formed, which may have a length, for example, of >200 μm and/or may be amenable to further processing to a weave structure, for example. This fiber may therefore be disposed in any of a very wide variety of configurations. In the case of the reaction conditions of reaction b), a substantially unordered mesh is obtained in which short silicon fibers are encased in a carbon shell C. In accordance with reaction c), individual silicon particles are produced, which are independent of one another and which are, again, encased in a carbon shell C obtained by carbonization of the polymer matrix. These particles may have a diameter in the range from ≧1 nm to ≦1000 nm, as for example ≧10 nm to ≦100 nm. To the skilled person it is understandable here that the aforesaid structures are intended to be only by way of example and without restriction.

In a further embodiment, the base element 2 may be an element of the kind that is able to serve only temporarily as a substrate for the application or generation of the silicon nanostructure, but does not serve as a constituent of an electrode. Instead, after the heat treatment, the nanostructure produced can be removed from the base body 2 and processed to a slurry with a solvent, such as N-methyl-2-pyrrolidone (NMP), acetone, tetrahydrofuran (THF), or methyl ethyl ketone (MEK), for example, or dispersed in the solvent. The slurry may then be applied to a base element for an electrode, for example in accordance with the so-called Bellcore technology, or by printing or knifecoating. The slurry or the dispersion here may further comprise, for example, a binder and/or conductive carbon. This embodiment may be suitable in particular for silicon nanoparticles as the silicon nanostructure. In this embodiment, it is possible to increase the density of silicon on the surface of the base element in the electrode, and hence to increase the capacity. In this embodiment, accordingly, the method of the disclosure encompasses the further steps of detaching the silicon nanostructure, more particularly comprising silicon nanoparticles, from the base element 2, dispersing the silicon nanostructure in a solvent, and applying the dispersion, more particularly by knifecoating or printing, to a base element of an electrode. The applied material may subsequently be dried.

What is claimed is:

1. A method for producing an electrode having an electrically conductive base element on which there is arranged an active material comprising a silicon nanostructure, the method comprising:
introducing a precursor mixture comprising a silicon-containing material and a base matrix into a spinning unit;
arranging an electrically conductive base body at a defined distance from a delivery device of the spinning unit;
delivering at least part of the precursor mixture from the delivery device to the base body;
applying an electrical voltage between at least part of the spinning unit and the base body so as to spin a silicon-containing nanostructure onto the base body;
heat-treating the silicon-containing nanostructure;
removing the heat-treated nanostructure from the base body;
processing the removed nanostructure to a slurry; and
applying the slurry to the base element to produce the electrode.

2. The method as claimed in claim 1, wherein the heat-treating is one or more of carried out in the absence of oxygen, carried out at a temperature in the range from ≧800 to ≦1000° C., and carried out for a period of ≧1 to ≦7 hours.

3. The method as claimed in claim 1, wherein the base body is formed of one or more of copper and aluminum.

4. The method as claimed in claim 1, wherein the applied voltage generates an electrical field of a magnitude in a range from ≧100 kV/m to ≦500 kV/m.

5. The method as claimed in claim 1, wherein spinning the silicon-containing nanostructure includes producing a wirelike silicon nanostructure having a length of >200 μm.

6. The method as claimed in claim 1, wherein the base matrix is a polyolefin.
